(19) United States
(12) Patent Application Publication
(10) Pub. No.: US 2024/0042612 A1
(43) Pub. Date: Feb. 8, 2024

(54) FORM SORTING SYSTEM, ROBOT CONTROL METHOD, AND RECORDING MEDIUM

(71) Applicants: NEC Corporation, Minato-ku, Tokyo (JP); NEC Solution Innovators, Ltd., Koto-ku, Tokyo (JP)

(72) Inventors: Ryo NAKAGAWA, Tokyo (JP); Masakazu ISHIDA, Tokyo (JP)

(73) Assignees: NEC Corporation, Minato-ku, Tokyo (JP); NEC Solution Innovators, Ltd., Koto-ku, Tokyo (JP)

(21) Appl. No.: 18/268,697

(22) PCT Filed: Mar. 25, 2021
(86) PCT No.: PCT/JP2021/012598

§ 371 Date: Jun. 21, 2023

(51) Int. Cl. B25J 9/16; B65H 39/10; B25J 9/00

(52) U.S. Cl. CPC B25J 9/1679; B65H 39/10; B25J 9/1697; B25J 9/0093

(57) ABSTRACT

A form sorting system according to an aspect of the present disclosure includes: at least one memory configured to store instructions; and at least one processor configured to execute the instructions to: recognize forms placed in a stack; and control a robot based on a result of the recognition, the robot controlled to pick up one or more of the forms placed in a stack and to place each one of the one or more of the forms to a conveyor so as not to overlap with another form, wherein the conveyor conveys forms to a sorting mechanism.

### TECHNICAL FIELD

The present disclosure relates to a form sorting system and the like.

### BACKGROUND ART

A store such as a convenience store handles a wide variety of forms having different sizes and contents, including substitute storage sheet, a slip, a gift certificate, and a receipt. These forms are collected from each store to an accounting center and classified by manual work. The contents of the classified forms are further registered in the system manually.

As a technique related to the present disclosure, PTL 1 discloses a form sorting processing device that reads data described in forms handled by financial institutions, determines the type of form from the data, and controls sorting and storage of the forms in a storage means. In PTL 1, an operator sets, in a hopper, a mixture of various types of statements of payment as forms to be sorted. The statements of payment set in the hopper are taken into the form sorting processing device one by one by a sending roller.

### CITATION LIST

### Patent Literature

PTL 1: JP 2006-143369 A

### SUMMARY OF INVENTION

### Technical Problem

PTL 1 discloses setting various kinds of statements of payment in a hopper, but does not disclose handling statements of payment of various sizes. Generally, in a device as disclosed in PTL 1, forms classified by size by an operator are set in a hopper for each size. In general, a form is set in a device such as PTL 1 with edges and corners of the form aligned. Therefore, it takes time and effort for the operator.

An object of the present disclosure is to provide a form sorting system or the like that makes sorting of forms efficient with a simple mechanism.

### Solution to Problem

A form sorting system according to the present disclosure includes a recognition means that recognizes forms placed in a stack, and a first control means that controls a robot based on a result of the recognition. The first control means controls the robot to hold one or more of the forms placed in a stack and to cause a conveyance means, which conveys forms to a sorting mechanism, to convey each of the one or more of the forms so as not to overlap with another form.

A robot control method according to the present disclosure includes recognizing forms placed in a stack, and controlling a robot, based on a result of recognition, to hold one or more of the forms placed in a stack and to cause a conveyance means, which conveys forms to a sorting mechanism, to convey each of the one or more forms so as not to overlap with another form.

A recording medium according to the present disclosure non-transitorily stores a program for causing a computer to execute recognizing a position of a form placed in a stack, and controlling a robot, based on a result of recognition, to hold one or more of the forms placed in a stack and to cause a conveyance means, which conveys forms to a sorting mechanism, to convey each of the one or more forms so as not to overlap with another form.

### Advantageous Effects of Invention

According to the present disclosure, sorting of forms can be made efficient with a simple mechanism.

### BRIEF DESCRIPTION OF DRAWINGS

FIG. 1 is a block diagram illustrating a configuration of a form sorting system 1 according to a first example embodiment.

FIG. 2 is a diagram illustrating an arrangement example of a robot 10, a conveyor 20, and a camera 30.

FIG. 3 is a block diagram illustrating a configuration of a robot control device 100.

FIG. 4 is a view illustrating an arrangement example of a conveyor 20 and a sorting device 40.

FIG. 5 is a flowchart illustrating an operation example of the form sorting system 1 according to the first example embodiment.

FIG. 6 is a diagram illustrating another arrangement example of the robot 10 and the conveyor 20.

FIG. 7 is a block diagram illustrating a configuration of a form sorting system 2 according to a second example embodiment.

FIG. 8 is a diagram illustrating an example of form data stored in a storage unit 205.

FIG. 9 is a flowchart illustrating an operation example of a form data generation device 200.

FIG. 10 is a block diagram illustrating an example of a hardware configuration of a computer 500.

### EXAMPLE EMBODIMENT

Hereinafter, a form sorting system according to an aspect of an example embodiment of the present disclosure will be described with reference to the drawings. In the present disclosure, a form is, for example, a substitute storage sheet, a slip, a gift certificate, a receipt, or the like handled in a store or the like. Here, the substitute storage sheet is, for example, a statement of payment of a fee for gas, telephone, electricity, tax, social insurance fee, e-commerce, or the like. However, among the forms listed above, there may be documents that are not handled. Other documents may be included in the form. In the present disclosure, a type of a form represents, for example, classification according to contents of the form. The type of the form may represent classification according to the size of the form.

### First Example Embodiment

### Configuration

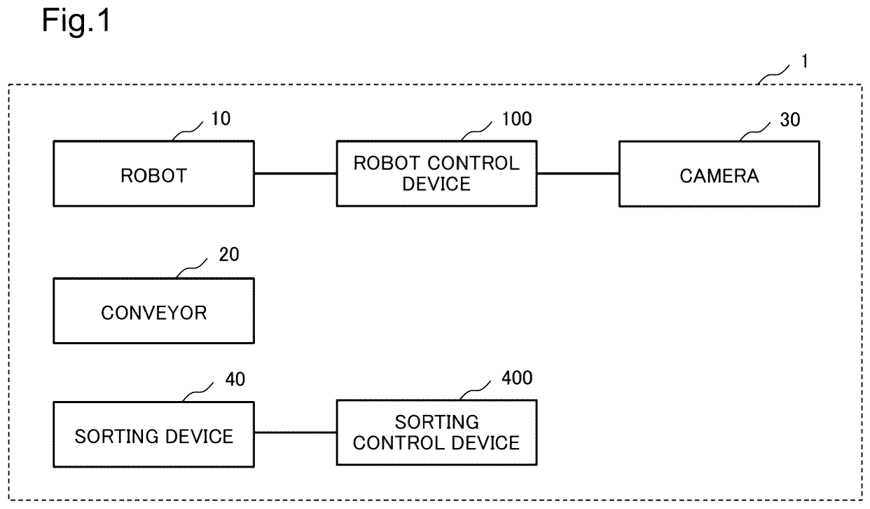

FIG. 1 is a block diagram illustrating a configuration of a form sorting system 1 according to a first example embodiment. The form sorting system 1 includes a robot 10, a robot control device 100, a conveyor 20, a camera 30, a sorting device 40, and a sorting control device 400. The robot control device 100 is connected to the robot 10 and the camera 30 so as to be able to communicate therewith in a wired or wireless manner. The sorting control device 400 is connected to the sorting device 40 so as to be able to communicate therewith in a wired or wireless manner. The robot control device 100 and the sorting control device 400 may be communicably connected or may not perform communication.

The robot 10 holds various types of forms set in a predetermined place and places the forms on the conveyor 20. The camera 30 photographs a form set in a predetermined place.

The conveyor 20 conveys a form to the sorting device 40. The conveyor 20 is, for example, a roller conveyor that conveys a form by rotating each of rollers disposed in parallel. The conveyor 20 may include a conveyor belt. The conveyor 20 is an example embodiment of a conveyance means.

The sorting control device 400 causes the sorting device 40 to sort forms. The sorting device 40 is, for example, a floating transfer mechanism that changes a conveyance direction of a form by floating and rotating one set of rollers of two sets of rollers disposed at right angles to a position higher than the other set of rollers. When one set of rollers rotates and a form to be sorted arrives on the other set of rollers, the sorting device 40 changes a conveyance direction of the forms to a direction of a sorting destination.

The sorting device 40 is an example embodiment of a sorting mechanism. The configuration of the sorting mechanism is not limited to the above configuration, and may be changed to another configuration.

The sorting device 40 sorts the forms into sorting destinations according to the type (content or size) of the form. For example, the sorting device 40 may sort forms according to the size of paper. The forms may be sorted according to contents such as substitute storage sheet, a slip, a gift certificate, a receipt, and other documents. Forms may be sorted by subsequent processing steps such as whether the forms are data input targets, whether the forms are storage targets, and whether the forms are return targets to a store. The forms may be further sorted by form name. In a case where the form is a gift certificate, the gift certificates may be further sorted according to whether they are cashing targets. A plurality of different types of forms may be sorted to the same sorting destination.

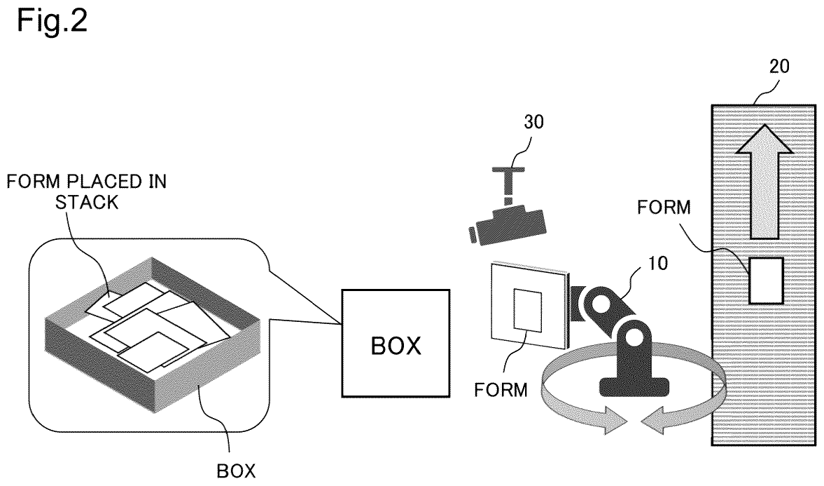

FIG. 2 is a diagram illustrating an arrangement example of the robot 10, the conveyor 20, and the camera 30. In the example of FIG. 2, forms are stacked in a box. Forms collected from convenience stores may be carried in bags for each store. For example, information for uniquely identifying a store is attached to the bag. The operator may take out the forms from the bag and put the forms in a different box for each store.

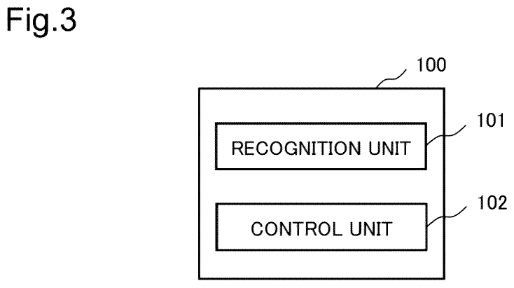

FIG. 3 is a block diagram illustrating a configuration of the robot control device 100. The robot control device 100 controls the robot 10. The robot control device 100 includes a recognition unit 101 and a control unit 102.

The recognition unit 101 recognizes a form placed in a stack based on an image photographed by the camera 30, for example. The recognition unit 101 is an example embodiment of a recognition means.

The recognition unit 101 may receive an image obtained by photographing a form from the camera 30. The recognition unit 101 recognizes, for example, a side or a corner of a form, and recognizes a position and a size of the form. The recognition unit 101 may recognize a position and a size of a form by recognizing a position of a character or a code printed in the form. Alternatively, the recognition unit 101 may receive the position and size of the form recognized by the camera 30.

For example, the recognition unit 101 recognizes an uppermost form in a box in which there is no upper form. The recognition unit 101 recognizes a form in which sides of the form, printed characters, or codes are not hidden by other forms.

The control unit 102 causes the robot 10 to hold a form based on a result of recognition by the recognition unit 101, and controls the robot 10 so that the robot 10 conveys the form to the conveyor 20. That is, the robot 10 places a form on the conveyor 20. The recognition result is, for example, a position or size of a form. The control unit 102 of the robot control device 100 is an example embodiment of a first control means.

The robot 10 holds, for example, one uppermost form using an existing technology. For example, the robot 10 may hold a form by gripping a side of the form like a human finger. Alternatively, the robot may cause a flat plate provided in the arm of the robot 10 or one or more contacts to suck the form by static electricity or air suction or discharge.

The control unit 102 controls the robot 10 so that a form held by the robot 10 is conveyed to the conveyor 20 so as not to overlap with other forms. For example, the control unit 102 controls the robot to convey a form to the conveyor 20 in empty spaces before and after another form conveyed to the conveyor 20. For example, the control unit 102 controls the robot 10 to place the next form after a predetermined time elapses after placing one form. During a lapse of a predetermined time, the conveyor 20 conveys the form and creates a space for placing a next form. When the size of the form recognized by the recognition unit 101 is larger than the size of other forms, the control unit 102 may set the time interval for placing the next form to be larger than the interval for placing other forms. Alternatively, a camera that captures an image on the conveyor 20 may be installed, and the control unit 102 may control the robot 10 to place a form in the photographed space.

The robot 10 may take out a plurality of forms from the box at a time as long as the forms can be placed on the conveyor 20 so as not to overlap. That is, the control unit 102 may control the robot 10 to hold two or more of the forms placed in a stack and convey each of the two or more forms to the conveyor 20.

The sorting device 40 sorts forms into a plurality of discharging units as sorting destinations according to types by an existing sorting technique. Types of forms to be sorted into sorting destinations (discharging units) are set in advance by an administrator or the like. Here, forms of different types may be sorted to the same sorting destination (discharging unit). In each sorting destination (discharging unit), forms can be stacked.

The sorting control device 400 controls the sorting device 40. The sorting control device 400 acquires a feature of a form, specifies a type of the form according to the acquired feature, and discriminates a sorting destination. The features of the form are, for example, the shape, size, and color of the form, or characters, codes, and the like printed in the form. The characters printed in the form indicate, for example, a form name. The code printed in the form is, for example, a bar code or a two-dimensional code indicating the type of the form.

In order to acquire features of a form, the sorting control device 400 may be connected to a camera 41 so as to be able to communicate therewith in a wired or wireless manner. The camera 41 photographs, for example, a form on the conveyor 20. The sorting control device 400 acquires features of a form based on an image. An image scanner or a barcode scanner may be used instead of the camera 41.

Instead of including the camera 41, the sorting control device 400 may acquire features of a form from an image photographed by the camera 30. In this case, for example, the robot control device 100 transmits the images of the forms photographed by the camera 30 to the sorting control device 400 in the order in which the forms are placed on the conveyor 20. The order of forms in which the sorting control device 400 receives images from the robot control device 100 is relevant to the order of forms conveyed to the sorting device 40 by the conveyor 20. The sorting control device 400 acquires features of forms from images sequentially received from the robot control device 100, and causes the sorting device to sort the forms sequentially conveyed. The sorting control device 400 may receive, in the robot control device 100, a feature of a form acquired based on an image of the form photographed by the camera 30 or a type of a specified form from the robot control device 100.

The sorting control device 400 may be formed integrally with the sorting device 40 or may be provided as a separate device.

Forms sorted to a sorting destination (discharging unit) may be further carried by an operator or a robot. For example, an operator or a robot takes out a form from a sorting destination (discharging unit) and carries the form to another device in order to register a description of the form in a system. Alternatively, an operator or robot carries the form to a predetermined storage. The storage is not particularly limited, and examples thereof include a room, a shelf, a case, a box, a container, a bag, a file, and a folder. When a storage means is installed in a sorting destination (discharging unit), an operator may carry a form together with the storage means. The type of the storage means installed in the sorting destination (discharging unit) is not particularly limited, and may be, for example, any of a case, a box, a container, and a bag.

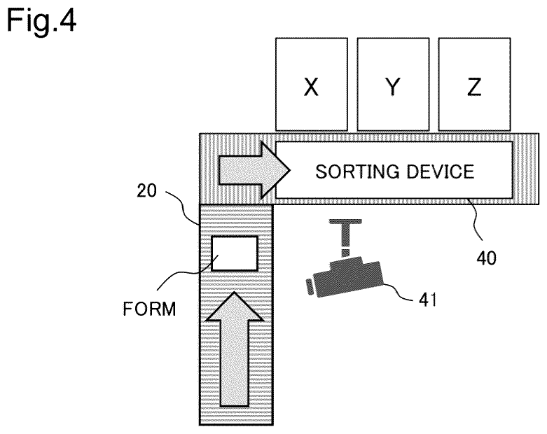

FIG. 4 is a view illustrating an arrangement example of the conveyor 20 and the sorting device 40. The sorting device 40 and the conveyor 20 may be integrally formed. In FIG. 4, storage means X, Y, and Z are installed in a sorting destination (discharging unit).

### Operation

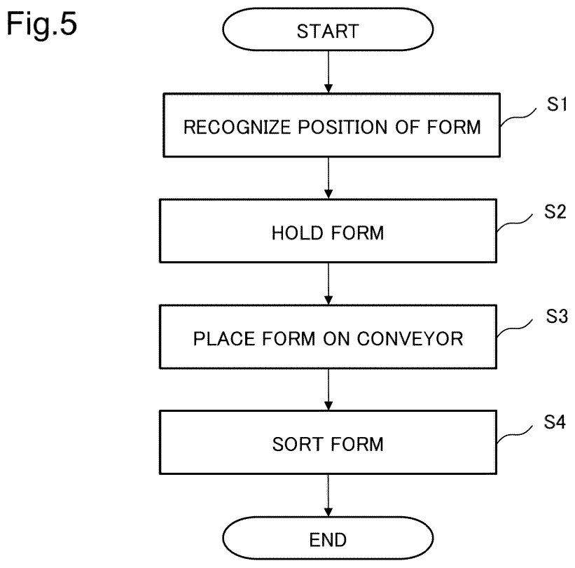

FIG. 5 is a flowchart illustrating an operation example of the form sorting system 1 according to the first example embodiment. First, the recognition unit 101 of the robot control device 100 recognizes the position of the form (step S1). The control unit 102 controls the robot based on the recognized position. The robot 10 holds one form under the control of the control unit 102 (step S2). Further, the robot 10 places the held form on the conveyor 20 (step S3). The conveyor 20 conveys the form to the sorting device 40. The sorting device 40 sorts the form according to the type (step S4). The description of the operation example of the form sorting system 1 ends.

### Effects

According to the first example embodiment, sorting of forms can be made efficient with a simple mechanism. The reason is that the robot holds one or more forms among the forms placed in a stack, and places each of the one or more forms on the conveyor 20 so as not to overlap with other forms. Further, this is because the conveyor 20 conveys a form to the sorting device 40. Further, according to the first example embodiment, the sorting work by a person can be automated by using the sorting device 40. As a result, even if the form is placed in a state where the orientation, position, and size of the form are not aligned, it is not necessary for the operator to align the form. As the sorting mechanism, a simple mechanism for sorting forms conveyed one by one can be used. Therefore, it is possible to efficiently sort forms with a simple mechanism.

In the case of using the device according to PTL 1, an operator needs to set a form straight in a hopper. In a case where the size of the form is different, there is a possibility that the form needs to be set for each size. According to the first example embodiment, the robot control device 100 recognizes the position of the stacked forms and causes the robot 10 to hold the forms. Therefore, an operator can collectively set forms of various sizes. Even when an operator stacks forms somewhat disorderly, forms can be efficiently sorted by the sorting device 40.

Meanwhile, as a method of sorting forms using a robot, a method of disposing a plurality of sorting destinations (discharging units) near the robot, and holding and transferring forms from a place where a plurality of types of forms are stacked to each sorting destination (discharging unit) can be assumed. However, in a case where the robot performs sorting, the operation of the robot becomes complicated as compared with the robot 10 according to the first example embodiment, so that the manufacturing cost may increase and the processing of the robot may be delayed. Further, since there is a limit to the number of sorting destinations (discharging units) that can be disposed near the robot, the types of forms that can be sorted are limited. According to the first example embodiment, it is possible to efficiently sort more types of forms.

### First Modification

The robot control device 100 may control the robot 10 so that the form is placed on the conveyor 20 with the upper, lower, left, and right directions of the form aligned. For example, the robot 10 may disposed forms on the conveyor 20 such that the arrangement angles of the upper ends of all forms are aligned.

When the vertical and horizontal directions and arrangement angles of the forms on the conveyor 20 are aligned, it is expected to reduce sorting errors and acquisition errors of features of the forms by the sorting mechanism. Since the forms are ejected in the same direction as the sorting destinations, when the storage means is installed in the sorting destinations, the forms can be stored in the same direction. Further, it is possible to move a form to a storage without aligning directions by an operator or a robot. When forms are stored in the same direction, management is facilitated.

Further, it is preferable that front and back directions of the forms are aligned when sorting and storing the forms. In order to align the directions of the front and back of the forms, the form sorting system 1 may further include a reversing mechanism of a form using an existing technology and a control device that controls the reversing mechanism.

The reversing mechanism reverses the face of the form on the conveyor 20. For example, when the back surface of a form placed on the conveyor 20 faces upward, the reversing mechanism reverses the form so that the front surface faces upward. When the surface faces upward, for example, the camera 41 can capture a feature of a form appearing on the surface on the conveyor.

The control device of the reversing mechanism recognizes a direction of a form based on an image of the form received from any camera. The camera for recognizing the direction of the form may be any of the camera 30 according to the first example embodiment, another camera for photographing an image on the conveyor 20, and the camera 41 according to the second example embodiment. The control device of the reversing mechanism is an example embodiment of a second control means. The control device of the reversing mechanism may be provided integrally with the robot control device 100 or the sorting control device 400, or may be provided separately from these devices.

### Second Modification

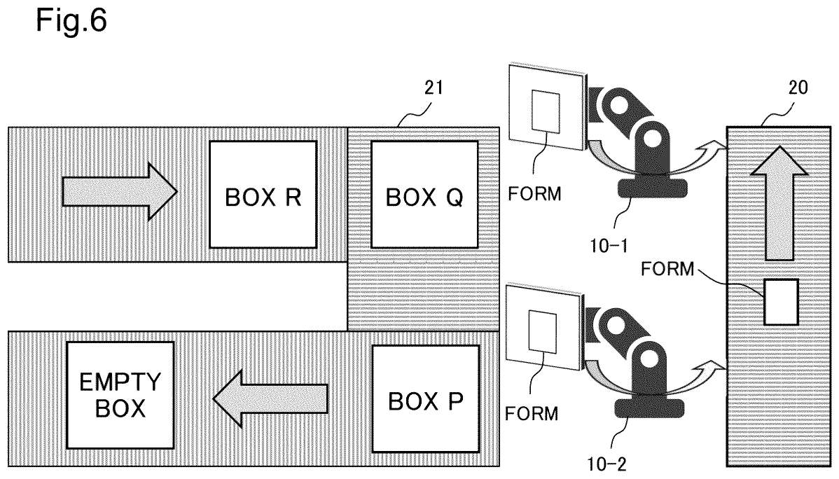

A plurality of robots 10 may be disposed for the conveyor 20 of one lane. FIG. 6 is a diagram illustrating another arrangement example of the robot 10 and the conveyor 20. In the example of FIG. 6, for example, a robot 10-1 places the form in a box Q on the conveyor 20, and a robot 10-2 places the form in a box P on the conveyor 20. The robot places a form on the conveyor 20 so as not to overlap the form placed by the robot 10-2.

At this time, the robot 10-1 and the robot 10-2 may be controlled by one robot control device 100. A plurality of cameras 30 may be provided for each robot 10 or for each box in which forms are stacked. The robot control device 100 receives an image of a form stacked in each box from each camera 30. However, one camera 30 may be provided, and a form in each of a plurality of boxes may be photographed by one camera 30.

Further, the robot 10-1 and the robot 10-2 may be controlled by different robot control devices 100.

In FIG. 6, a conveyor 21 is a conveyance means that conveys boxes containing stacked forms to the position of the robot 10. The conveyor 21 may further convey an empty box from which all forms have been taken out by the robot 10.

### Second Example Embodiment

### Configuration

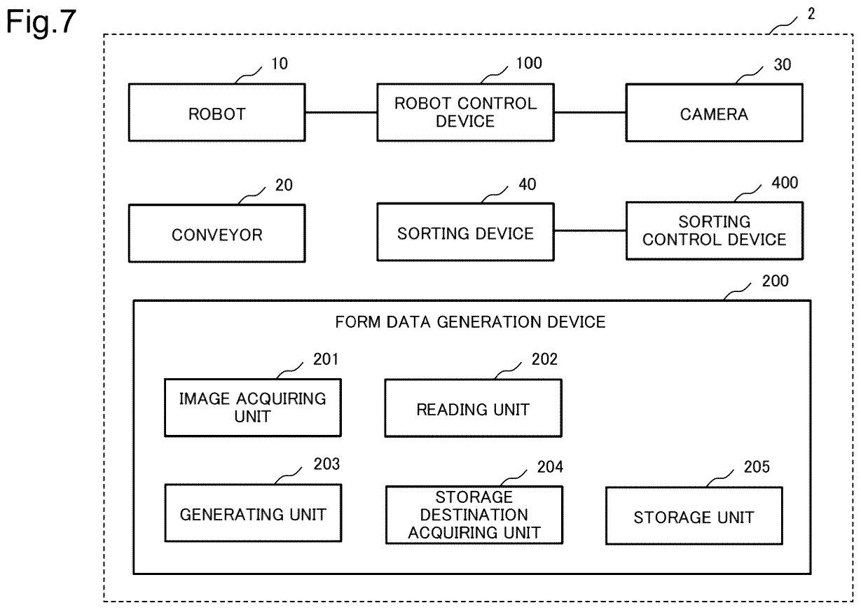

FIG. 7 is a block diagram illustrating a configuration of a form sorting system 2 according to a second example embodiment. The form sorting system 2 further includes a form data generation device 200 as compared with the form sorting system 1 according to the first example embodiment. Description of configurations similar to those according to the first example embodiment will be omitted. The form data generation device 200 may be connected to the robot control device 100 and the sorting control device 400 so as to be able to communicate therewith in a wired or wireless manner.

The form data generation device 200 includes an image acquiring unit 201, a reading unit 202, a generating unit 203, a storage destination acquiring unit 204, and a storage unit 205. The form data generation device 200 may not include some of the above components. Each component of the form data generation device 200 may be achieved by a combination of a plurality of devices.

The image acquiring unit 201 acquires an image of a form from a camera disposed at any position where forms to be sorted can be photographed. The image acquiring unit 201 may acquire an image of a form to be sorted set in the above-described place from the camera 30. Alternatively, the image acquiring unit 201 may acquire an image of a form on the conveyor 20 from the camera 41 or another camera used by the sorting control device 400. Alternatively, the image acquiring unit 201 may acquire images of sorted forms from the cameras installed in the sorting destinations (discharging units).

When the image acquiring unit 201 acquires images from the cameras 30 and 41, it is not necessary to provide a camera for creating form data to be described later separately from the cameras 30 and 41, and the cost can be reduced.

The reading unit 202 reads a description in a form based on the image acquired by the image acquiring unit 201. The reading unit 202 reads a description in a form by recognizing text in an image by, for example, optical character recognition (OCR) technology. The reading unit 202 may read a description in a form for each item included in the form.

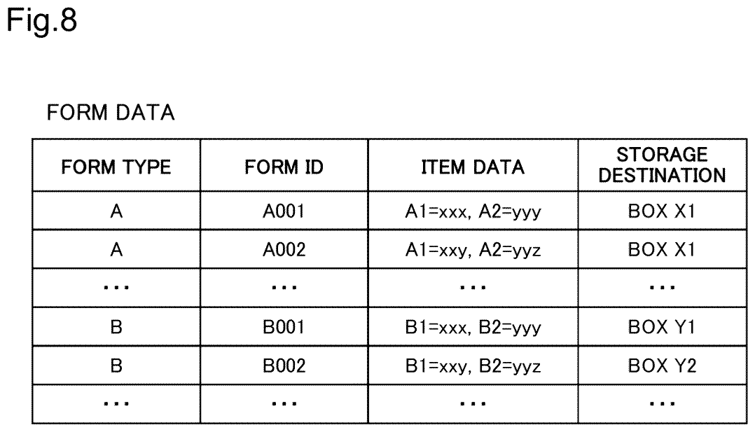

The generating unit 203 generates form data indicating a description of a form read by the reading unit 202. The generating unit 203 stores the form data in the storage unit 205. Adding form data to the storage unit 205 is also referred to as registration of a form in a system. FIG. 8 is a diagram illustrating an example of form data stored in the storage unit 205.

The form data includes a form type, a form identifier (ID), and item data. The form type indicates a type (content or size) of the form described above. For example, the form type may indicate whether the form is any of a substitute storage sheet, a slip, a gift certificate, a receipt, and other documents. Alternatively, the form type may indicate a form name or a size of a form. The type of form is determined by the reading unit 202, for example, similarly to the sorting control device 400.

The form ID is an identifier for uniquely identifying a form. The generating unit 203 may attach a form ID to the read form. Alternatively, the generating unit 203 may use a result obtained by the reading unit 202 reading a form ID printed in a form as the form ID.

The item data is data indicating items described for each item included in a form. Items included in a form may be different depending on the type (content) of the form. In the example of FIG. 8, for example, the form of a form type A includes an item A1 and an item A2. The reading unit 202 reads that data xxx is described in the item A1 and data yyy is described in the item A2 in the form having the form ID A001.

The form data may further include a storage destination of the read form. The storage destination is, for example, an identifier of a storage means installed in a sorting destination (discharging unit). The storage destination may be an identifier for identifying a storage where a form is stored. The storage destination may be a combination of an identifier for identifying a storage where a form is stored and an identifier of a storage means.

The storage destination acquiring unit 204 acquires a storage destination of a form for each form to be read.
(1) When the storage destination is an identifier of a storage means installed in a sorting destination (discharging unit), the storage destination acquiring unit 204 acquires a storage destination storing a form to be read as follows, for example.
(1.1) For example, when the image acquiring unit 201 acquires an image of a form to be read from a camera of each sorting destination (discharging unit), the storage destination acquiring unit 204 specifies an identifier of a storage means that stores the form from an image of the storage means photographed together with the form to be read (sorted).
(1.2) When the image acquiring unit 201 acquires an image of a form to be read from the camera 30, the camera 41, or the like, an identifier of a storage means that stores the form can be specified as follows. For example, the storage destination acquiring unit 204 first acquires a form ID of a form to be read specified by the reading unit 202. Further, the storage destination acquiring unit 204 acquires the form IDs of the sorted forms acquired from the images photographed by the cameras of the sorting destinations (discharging units) and the identifiers of the storage means in which the forms are stored. The storage destination acquiring unit 204 specifies an identifier of a storage means in which the form is stored based on the acquired form ID and the identifier of the storage means.
(1.3) Similarly to (1.2), when the image acquiring unit 201 acquires an image of a form to be read from the camera 30, the camera 41, or the like, an identifier of a storage means that stores the form can be specified as follows. For example, the storage destination acquiring unit 204 obtains an order in which the forms are sorted to a sorting destination (discharging unit) based on an order of images of the acquired forms (order of sorting by the sorting device 40) and types of the forms. Then, the image acquiring unit 201 specifies an identifier of a storage means in which the read forms are stored from the number of forms stored in each storage unit sequentially installed and replaced in the sorting destination (discharging unit) and the identifier of the storage means. In this case, an identifier of each storage means sequentially installed and replaced in each sorting destination (discharging unit) and the number of forms stored in the storage means may be input by an operator, or may be acquired from an image photographed by a camera of each sorting destination (discharging unit).
(2) When the storage destination is an identifier for identifying a storage where a form is stored, the storage destination acquiring unit 204 acquires a storage destination where a read form is stored as follows, for example.

For example, the storage destination acquiring unit 204 acquires an identifier of a storage where each storage means is conveyed by an input from an operator or a robot who conveys the storage means. Then, the storage destination acquiring unit 204 specifies an identifier of a storage means in which a form to be read is stored, based on the identifier of the storage means in which the form to be read is stored and the identifier of the storage in which each storage means is conveyed, which are specified by the above-described method.

In the example of FIG. 8, the form A001 is stored in a box Xl. By storing the storage destination, an actual form relevant to data can be managed.

The form data may further include an image of the form. That is, the generating unit 203 may further store the image of the form acquired by the image acquiring unit 201 in the storage unit 205. Then, the form data generation device 200 may display the stored form data and the image in association with each other on any display. By displaying the image, the operator can compare the image with the read item data.

### Operation

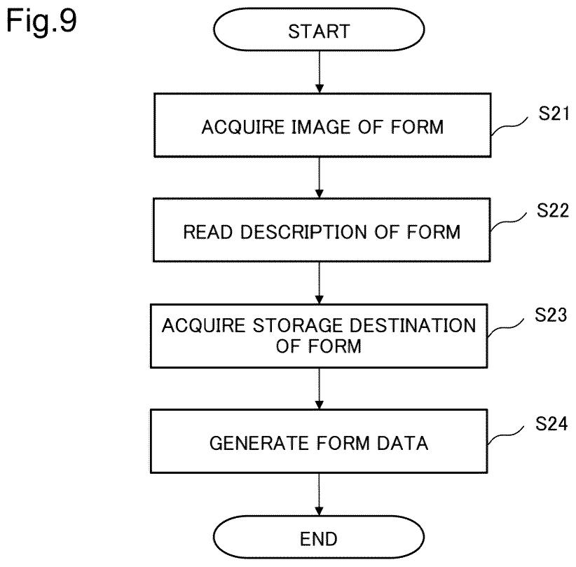

An operation example of the form sorting system 2 according to the second example embodiment will be described. The operations of the robot 10, the robot control device 100, the conveyor 20, and the sorting device 40 are the same as those in the first example embodiment, and thus the description thereof will be omitted. FIG. 9 is a flowchart illustrating an operation example of the form data generation device 200.

First, the image acquiring unit 201 acquires an image of a form (step S21). Step S21 may be performed before step S1 in FIG. 5 or after any of steps S1 to S4.

The reading unit 202 reads a description of a form based on the acquired image of the form (step S22).

The storage destination acquiring unit 204 acquires a storage destination of a form (step S23).

The generating unit 203 generates form data including the description read by the reading unit 202 (step S24).

### Effects

According to the second example embodiment, it is possible to automate work in which a person looks at a form and inputs a description of the form to a system. This is because the image acquiring unit 201 acquires an image of a form, the reading unit 202 reads a description of the form, and the generating unit 203 generates form data and registers the form data in the storage unit 205.

### Hardware Configuration

In each of the example embodiments described above, each component of the robot control device 100 and the form data generation device 200 represents a block of functional units. A part or all of each component of each device may be achieved by any combination of the computer 500 and the program.

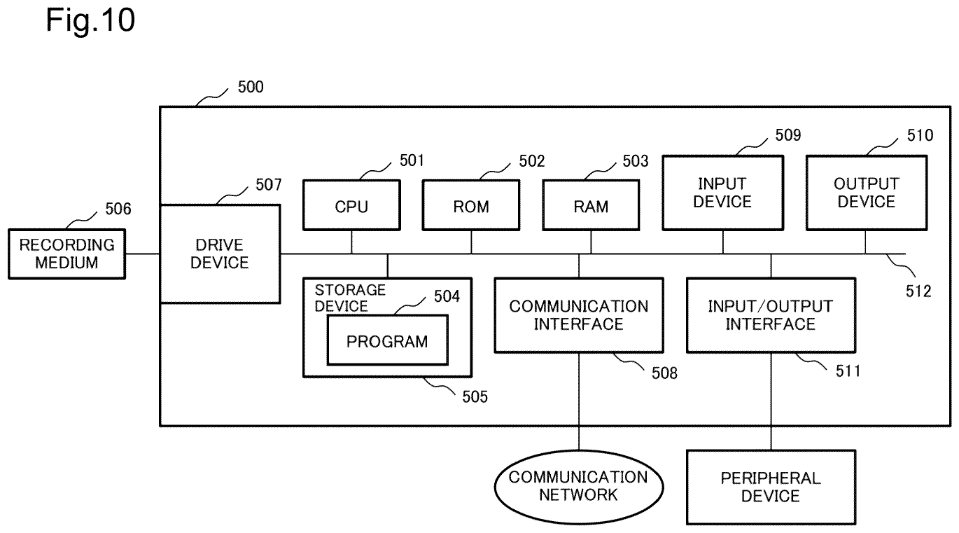

FIG. 10 is a block diagram illustrating an exemplary hardware configuration of a computer 500. Referring to FIG. 10, the computer 500 includes, for example, a central processing unit (CPU) 501, a read only memory (ROM) 502, a random access memory (RAM) 503, a program 504, a storage device 505, a drive device 507, a communication interface 508, an input device 509, an input/output interface 511, and a bus 512.

The program 504 includes an instruction for achieving each function of each device. The program 504 is stored in advance in the ROM 502, the RAM 503, and the storage device 505. The CPU 501 achieves each function of each device by executing instructions included in the program 504. For example, the CPU 501 of the robot control device 100 executes a command included in the program 504 to achieve the function of the robot control device 100. The RAM 503 may store data to be processed in each function of each device. For example, the form position in the robot control device 100 may be stored in the RAM 503 of the computer 500.

Drive device 507 for reading and reading recording medium 506 The communication interface 508 provides an interface with a communication network. The input device 509 is, for example, a mouse, a keyboard, or the like, and receives an input of information from an administrator of the form sorting system 1. The output device 510 is, for example, a display, and outputs (displays) information to an administrator or the like. The input/output interface 511 provides an interface with a peripheral device. The bus 512 connects the components of the hardware. The program 504 may be supplied to the CPU 501 via the communication network, or may be stored in advance in the recording medium 506, and the drive device 507 may read the program and supply the program to the CPU 501.

The hardware configuration illustrated in FIG. 10 is an example, and other components may be added or some components may not be included.

There are various modifications of the method of achieving each device. For example, each device may be achieved by any combination of a computer and a program different for each component. A plurality of components included in each device may be achieved by any combination of one computer and a program.

Some or all of the components of each device may be achieved by general-purpose or dedicated circuitry including a processor or the like, or a combination thereof. These may be configured by a single chip or may be configured by a plurality of chips connected via a bus. Some or all of the components of each device may be achieved by a combination of the above-described circuit and the like and a program.

In a case where a part or all of each component of each device is achieved by a plurality of computers, circuits, and the like, the plurality of computers, circuits, and the like may be arranged in a centralized manner or in a distributed manner.

At least a part of the form sorting systems 1 and 2 may be provided in a software as a service (SaaS) format. That is, at least a part of the functions for achieving the robot control device 100 and the form data generation device 200 may be executed by software executed via a network.

Although the present disclosure has been particularly shown and described with reference to the present example embodiment, the present disclosure is not limited to the above example embodiment. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

### Reference Signs List

10 robot

100 robot control device

20, 21 conveyor

30, 41 camera

40 sorting device

400 sorting control device

500 computer

What is claimed is:

1. A form sorting system comprising:
at least one memory configured to store instructions; and
at least one processor configured to execute the instructions to:
recognize forms placed in a stack; and
control a robot based on a result of the recognition, the robot controlled to pick up one or more of the forms placed in a stack and to place each one of the one or more of the forms to a conveyor so as not to overlap with another form, wherein
the conveyor conveys forms to a sorting mechanism.

2. The form sorting system according to claim 1, wherein the at least one processor is further configured to execute the instructions to:
control the robot to place the one or more forms in empty spaces of the conveyor before and after the other forms conveyed by the conveyance means.

3. The form sorting system according to claim 1, wherein the at least one processor is further configured to execute the instructions to:
control a reversing mechanism for reversing a form surface in the conveyor.

4. The form sorting system according to claim 1, wherein the at least one processor is further configured to execute the instructions to:
read a description of a form from an image obtained by capturing the form placed in a stack; and
generate form data indicating a description of the form.

5. The form sorting system according to claim 1, wherein the at least one processor is further configured to execute the instructions to:
read a description of a form from an image obtained by capturing any one of a form conveyed by the conveyor and a form sorted by the sorting mechanism; and
generate form data indicating a description of the form.

6. The form sorting system according to claim 4, wherein the at least one processor is further configured to execute the instructions to:
generate form data including an image of the form.

7. The form sorting system according to claim 4, wherein the at least one processor is further configured to execute the instructions to:
generate form data including a storage destination of the form.

8. A robot control method comprising:
recognizing forms placed in a stack; and
controlling a robot, based on a result of recognition, to pick up one or more of the forms placed in a stack and to place each of the one or more forms to a conveyor so as not to overlap with another form, wherein the conveyor conveys forms to a sorting mechanism.

9. A recording medium non-transitorily storing a program causing a computer to execute:
recognizing a position of a form placed in a stack; and
controlling a robot, based on a result of recognition, to pick up one or more of the forms placed in a stack and to place each of the one or more forms to a conveyor so as not to overlap with another form, wherein the conveyor conveys forms to a sorting mechanism.

10. The form sorting system according to claim 5, wherein the at least one processor is further configured to execute the instructions to:
generate form data including at least one of an image of the form, or a storage destination of the form.
